(19) United States
(12) Patent Application Publication
(10) Pub. No.: US 2026/0321147 A1
(43) Pub. Date: Oct. 15, 2026

(54) METHOD AND DEVICE FOR DETERMINING MOVEMENT STATE OF ADVANCED AIR MOBILITY WITHIN AIRSPACE SEGMENT

(71) Applicant: SK TELECOM CO., LTD., Seoul (KR)

(72) Inventors: Jeongseok KIM, Seoul (KR); Kangjin KIM, Seoul (KR)

(21) Appl. No.: 19/122,450

(22) PCT Filed: Oct. 19, 2023
(86) PCT No.: PCT/KR2023/016285

§ 371 Date: Apr. 18, 2025

(30) Foreign Application Priority Data
Oct. 19, 2022 (KR) 10-2022-0134861

(51) Int. Cl. G08G 5/72; G01C 23/00

(52) U.S. Cl. CPC G08G 5/72; G01C 23/00

(57) ABSTRACT

A method for determining a movement state of advanced air mobility (AAM) within an airspace segment, according to one embodiment, may comprise the steps of: determining an airspace segment, from among a plurality of airspace segments set on a flight route, in which the movement state of the AAM is to be identified; identifying whether the AAM is located within the airspace segment; and as a result of the identification, if the AAM is located within the airspace segment, determining the movement state of the AAM within the airspace segment on the basis of location information of the AAM.

### CROSS-REFERENCE TO RELATED APPLICATION

This application is a National Stage application under 35 U.S.C. § 371 of International Application No. PCT/KR2023/016285, filed on Oct. 19, 2023, which claims the benefit of Korean Patent Application No. 10-2022-0134861 filed on Oct. 19, 2022. The disclosures of the prior applications are incorporated by reference in their entireties.

### TECHNICAL FIELD

The present disclosure relates to a method and device for determining the movement state of advanced air mobility (AAM) in an airspace segment.

This research was conducted with the support of the Ministry of Land, Infrastructure, and Transport/Korea Agency for Infrastructure Technology Advancement (Project Number: RS-2022-00143965).

### BACKGROUND ART

AAM refers to the advanced air mobility, utilizing the sky as a transportation route by combining vertical take-off and landing (VTOL) capable personal air vehicles (PAV).

AAM, as a next-generation mobility solution that maximizes transportation efficiency in urban areas, has emerged to address issues such as the decline in mobility efficiency due to congestion in urban traffic, rising social costs like logistics transportation expenses, and other related challenges. With long-distance travel times increasing and traffic jams getting worse, AAM is seen as a solution to these problems while also being regarded as a future innovation business.

Meanwhile, in order to monitor the operation of AAM, a system that controls the operation may consider a method of dividing the flight route of the AAM into a plurality of airspace segments, and mapping the AAM located in each divided airspace segment.

However, in case of such a method, the approach may be problematic as it may be necessary to monitor the movement state of the AAM within the airspace segment, in order to monitor the operation of AAM more precisely.

### DISCLOSURE

### Technical Problem

The problem to be solved in the present disclosure is directed to providing a method and device for determining the movement state of AAM within an airspace segment.

However, the problem to be solved in the present disclosure is not limited to that mentioned above, and other problems to be solved that are not mentioned may be clearly understood by those of ordinary skill in the art to which the present disclosure belongs from the following description.

### Technical Solution

According to a first aspect, there is provided a method of determining a movement state of an advanced air mobility (AAM) within an airspace segment. The method may include determining an airspace segment to identify a movement state of an AAM among a plurality of airspace segments set on a flight route; identifying whether the AAM is located in the determined airspace segment; and determining the movement state of the AAM within the determined airspace segment based on location information on the AAM when the AAM is located in the determined airspace segment based on a result of the identification.

The determining of the airspace segment to identify the movement state of the AAM may include identifying at least one airspace segment located within a region of interest among the plurality of airspace segments; and determining an airspace segment to identify a movement state of the AAM among the at least one identified airspace segment, based on a predetermined determination criterion.

The region of interest may be one of a region near a vertiport, a region corresponding to a waypoint, a region corresponding to a dense residential area, a region corresponding to a migratory bird path, a region corresponding to a high-rise building area, or a region where an event has occurred or is expected to occur.

In the identifying of whether the AAM is located in the determined airspace segment, it may be further identified, by the determined airspace segment, whether the AAM is located in an adjacent airspace segment of the determined airspace segment through the airspace segment, and wherein the determining of the movement state of the AAM may include, when the AAM is identified to be located in the adjacent airspace segment, determining the movement state of the AAM within the adjacent airspace segment based on the location information on the AAM.

The identifying of whether the AAM is located in the adjacent airspace segment may be performed using information on the AAM that has entered or exited the adjacent airspace segment, which is obtained from the airspace segment.

The determining of the movement state of the AAM may include determining a direction of movement of the AAM using the location information on the AAM; and determining the movement state of the AAM within the determined airspace segment based on the location information and the direction of movement.

The determining of the movement state of the AAM may include determining a direction of movement of the AAM using the location information of the AAM; determining, when a shape of the airspace segment is a polyhedron, an entry surface or an exit surface among a plurality of surfaces constituting the polyhedron, based on at least one of the direction of movement or a preset operation path of the AAM; and determining a movement state for the determined entry surface or the determined exit surface.

A shape of the airspace segment may be a polyhedron, and the determining of the movement state of the AAM may include generating a straight line for each of at least one surface among a plurality of surfaces constituting the polyhedron, wherein the straight line is perpendicular to corresponding surface and has a length corresponding to a diameter of a circumscribed sphere of the determined airspace segment; and determining a movement state of the AAM with respect to each of the at least one surface, based on a location of the AAM on the straight line generated for each of the at least one surface.

The determining of the movement state of the AAM may include determining a direction of movement of the AAM using the location information of the AAM; and determining the movement state of the AAM with respect to a center point of the airspace segment based on the location information and the direction of movement.

The determination of the airspace segment to identify the movement state of the AAM may include identifying an airspace segment present on a planned flight path on which the AAM moves from a starting point to a destination, calculating a relative distance between a center point of the identified airspace segment and a location of the AAM, and determining the airspace segment to identify the movement state of the AAM based on the calculated relative distance.

The relative distance may be calculated for each of two or more airspace segments present on the planned flight route, and the method further may include selecting an airspace segment among the two or more airspace segments with the calculated relative distance smaller than a reference distance used to determine a range of the airspace segment, and wherein the selected airspace segment may be determined as the airspace segment for identifying the movement state of the AAM in the determining the airspace segment to identify the movement state of the AAM.

The selecting the airspace segment among the two or more airspace segments may include sorting each of the calculated relative distances in ascending order; and comparing a relative distance of a smallest value with the reference distance, wherein, when the relative distance of the smallest value is smaller than the reference distance, the airspace segment with the relative distance of the smallest value may be determined as the airspace segment to identify the movement state of the AAM.

The determining of the airspace segment to identify the movement state of the AAM may include identifying a previous airspace segment detected in a previous time unit; identifying a direction vector of the AAM and an elapsed time within the previous airspace segment, and calculating a maximum expected distance based on the direction vector of the AAM and the elapsed time; predicting airspace segments present within a range of the maximum expected distance as target regions; and determining one of the predicted target regions as the airspace segment to identify the movement state of the AAM.

The determining of the airspace segment to identify the movement state of the AAM may include selecting candidate segments from among airspace segments present within a predetermined range; and searching the selected candidate segments to determine the airspace segment to identify the movement state of the AAM.

According to a second aspect, there is provided a movement state determination device. The device may include a memory storing a movement state determination program that includes instructions programmed to determine a movement state of an advanced air mobility (AAM) within an airspace segment; and a processor configured to execute the movement state determination program to determine an airspace segment to identify the movement state of the AAM among a plurality of airspace segments set on a flight route, identify whether the AAM is located in the determined airspace segment, and, based on a result of the identification, when the AAM is located in the airspace segment, determine the movement state of the AAM within the determined airspace segment based on location information of the AAM.

According to a third aspect, there is provided a non-transitory computer-readable recording medium storing instructions, when executed by a processor to cause the processor to determine a movement state of an advanced air mobility (AAM) within an airspace segment. The method may include determining an airspace segment to identify a movement state of an AAM among a plurality of airspace segments set on a flight route; identifying whether the AAM is located in the determined airspace segment; and determining the movement state of the AAM within the determined airspace segment based on location information on the AAM when the AAM is located in the determined airspace segment based on a result of the identification.

### Advantageous Effects

According to an embodiment of the present disclosure, the monitoring of an aircraft within an airspace segment can be performed more precisely by determining the aircraft's movement state within the airspace segment based on its location information and direction of movement.

### DESCRIPTION OF DRAWINGS

FIG. 1 is a block diagram illustrating a movement state determination device according to an embodiment.

FIG. 2 is a block diagram conceptually illustrating the function of a movement state determination program according to an embodiment.

FIG. 3 is a view illustrating the structure of airspace segments provided within an airspace.

FIG. 4 is a view illustrating the distance relationship of an aircraft within airspace segments.

FIG. 5 is a view illustrating the cell structure of an airspace segment.

FIG. 6 is a view illustrating airspace segments being searched from surrounding airspace segments located around a previous airspace segment.

FIG. 7 illustrates an airspace segment set in a spherical shape.

FIG. 8 illustrates an airspace segment set in a non-spherical shape.

FIG. 9 is an example illustrating the movement state of an aircraft based on a surface within an airspace segment set in a polyhedron.

FIG. 10 is a flowchart illustrating a method of determining the movement state of an aircraft according to an embodiment.

FIG. 11 is a flowchart illustrating in detail the operation of the step of determining the airspace segment in S1010 of FIG. 10.

### MODE FOR DISCLOSURE

The advantages and features of embodiments and methods of accomplishing these will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing the embodiments of the present disclosure, if it is determined that detailed description of related known components or functions unnecessarily obscures the gist of the present disclosure, the detailed description thereof will be omitted. Further, the terminologies to be described below are defined in consideration of functions of the embodiments of the present disclosure and may vary depending on a user's or an operator's intention or practice. Accordingly, the definition thereof may be made on a basis of the content throughout the specification.

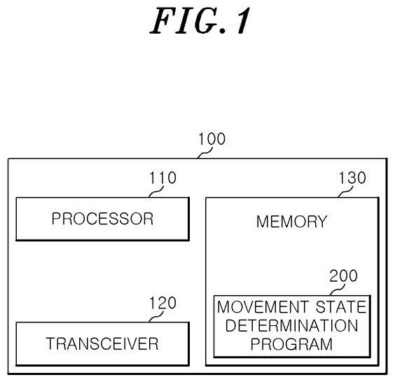

FIG. 1 is a block diagram illustrating a movement state determination device according to an embodiment.

With reference to FIG. 1, a movement state determination device 100 may include a processor 110, a transceiver 120, and a memory 130.

The processor 110 may control the overall operation of the movement state determination device 100.

The processor 110, using the transceiver 120, may receive a request for the identification of the movement state of an aircraft within a region of interest from a user of the movement state determination device 100 or from another device (or system).

According to an embodiment, the movement state determination device 100 may be included in a device or system operated by an urban air traffic management service provider (UATMSP), an operation support information provider, a value-added service provider, an airspace segment manager, and the like.

In this specification, the airspace segment refers to a region conceptually divided by a flight route, and the flight route may refer to an airspace in which aircraft such as AAMs and drones are capable of operating.

The memory 130 may store a movement state determination program 200 and the information necessary for the execution of the movement state determination program 200.

In this specification, the movement state determination program 200 may refer to software including instructions programmed to determine an airspace segment that is used for identifying information on a given aircraft among a plurality of airspace segments set along a flight route, and to determine the movement state of the corresponding aircraft within the determined airspace segment.

In this specification, the movement state of an aircraft refers to the direction and extent of the aircraft's movement within a given airspace segment, and may indicate the progress of the aircraft within the given airspace segment. For example, when a shape of a given airspace segment is a polyhedron, the movement state of the aircraft may be expressed as the extent of movement of the aircraft based on at least one surface among the plurality of surfaces constituting the polyhedron.

The processor 110 may load the movement state determination program 200 and information necessary for the execution of the movement state determination program 200 from the memory 130 in order to execute the movement state determination program 200.

The processor 110 may execute the movement state determination program 200 to determine an airspace segment that identifies information on a given aircraft among a plurality of airspace segments set along a flight route, and to determine the movement state of the corresponding aircraft within the determined airspace segment.

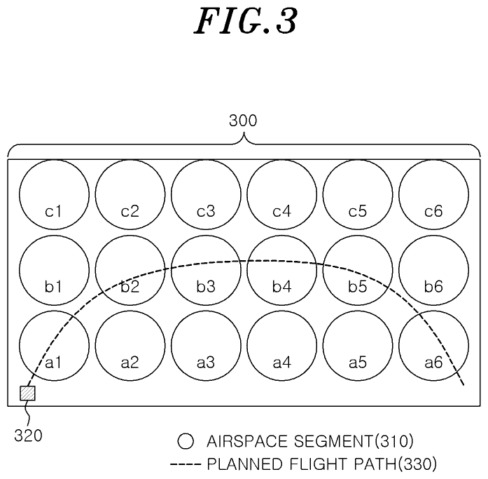

The function and/or operation of the movement state determination program 200 will be described in detail with reference to FIG. 3.

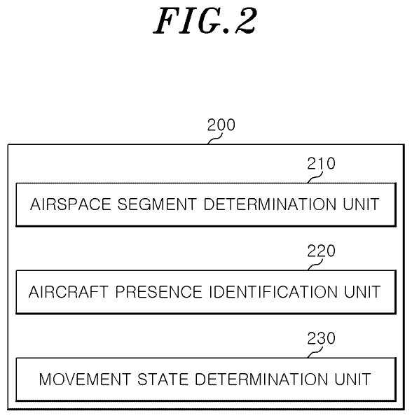

FIG. 2 is a block diagram conceptually illustrating the function of a movement state determination program according to an embodiment.

With reference to FIG. 1 and FIG. 2, the movement state determination program 200 may include an airspace segment determination unit 210, an aircraft presence identification unit 220, and a movement state determination unit 230.

The airspace segment determination unit 210, aircraft presence identification unit 220, and movement state determination unit 230 illustrated in FIG. 2 are conceptually divided functions of the movement state determination program 200 for ease of explanation. These are not to be considered as limitations of the movement state determination program 200. According to embodiments, each of the functions of the airspace segment determination unit 210, the aircraft presence identification unit 220, and the movement state determination unit 230 may be merged or separated, and may be implemented as a series of instructions within a single program.

The airspace segment determination unit 210 may determine the airspace segment to identify the movement state of the aircraft among the plurality of airspace segments set along the flight route.

More specifically, the airspace segment determination unit 210 may identify at least one airspace segment located within the region of interest among the plurality of airspace segments, and determine the airspace segment to identify the movement state of the aircraft from the at least one identified airspace segment, based on a predetermined determination criterion.

The region of interest may include a region near a vertiport, a region corresponding to a waypoint, a region corresponding to a dense residential area, a region corresponding to a migratory bird path, a region corresponding to a high-rise building area, and a region where an event has occurred or is expected to occur.

The event may include a one-time, regular, or irregular incident related to the operation of the aircraft, such as a fire in a high-rise building, the presence of other types of aircraft not controlled by the operation control device in the air, such as a hot air balloon, the migration of birds, or the occurrence of weather conditions such as localized heavy rain, hail, or gusts.

According to embodiments, the determination criterion may include methods such as selecting an arbitrary airspace segment from the at least one airspace segment, selecting an airspace segment located at the center or outer edge of the region of interest, and selecting a special management area within the region of interest, such as an area where an event has directly occurred, an area where a tallest building is located, or an area corresponding to particularly adverse weather conditions.

Hereinafter, the operation of the airspace segment determination unit 210 in determining the airspace segment will be specifically illustrated with reference to FIG. 3 through FIG. 6.

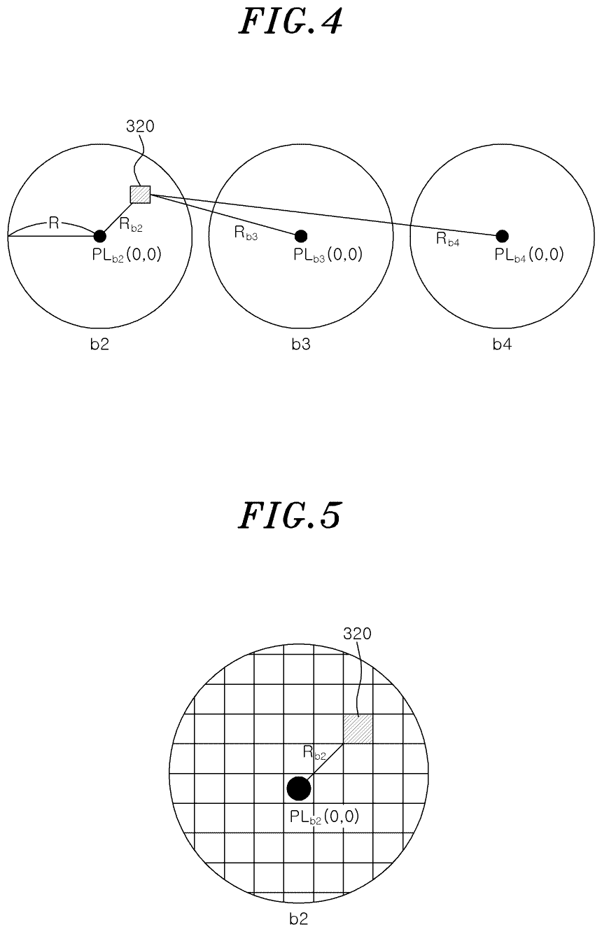

FIG. 3 is a view illustrating the structure of airspace segments provided within a flight route, and FIG. 4 is a view illustrating the relative distance relationship of an aircraft within the airspace segments.

The structure of the airspace segments illustrated in FIG. 3 is only an exemplary representation, and the present disclosure is not limited to this structure. The structure of the airspace segments may be variably modified and distributed. For example, the airspace segments may be distributed in an irregular shape, and the airspace segments may be arranged to overlap each other or distributed spaced apart by at irregular distances.

A flight route 300 may exist from the starting point to the destination, and the flight route 300 may be divided into a plurality of airspace segments 310. A path to be moved from the starting point to the destination (hereinafter referred to as the ‘planned flight path’ 330) may be planned, and the aircraft 320 may be controlled to move along the planned flight path. For example, the aircraft 320 may move to the destination by passing through airspace segments a1, b2, b3, b4, b5, and a6, which are located on the planned flight path 330. Based on this, the airspace segment determination unit 210 may perform the operation of searching airspace segments, initially targeting the airspace segments a1, b2, b3, b4, b5, and a6 located on the planned flight path 330. As an example, the airspace segment determination unit 210 may calculate a relative distance between the location (loc(i)) of the aircraft 320 and the center point of the airspace segment a1, b2, b3, b4, b5, or a6 using Equation 1 below, and determine the airspace segment using the relative distance calculated for each of the center points of the airspace segment a1, b2, b3, b4, b5, and a6.

Rᵢ=∥PLᵢ(0,0)−loc(i)∥₂ [Equation 1]

Here, Rᵢ represents a relative distance between the location of the aircraft and each airspace segment, PLᵢ(0,0) represents the center point of each airspace segment, and loc(i) represents the location of the aircraft.

Specifically, as illustrated in FIG. 4, it is assumed that the aircraft is present in the second airspace segment b2, and the second airspace segment b2, the third airspace segment b3, and the fourth airspace segment b4 are sequentially arranged on the planned flight path. When the airspace segment determination unit 210 calculates the relative distances between the location of the aircraft (loc(i)) and the airspace segments b2, b3, and b4, the relative distance for the second airspace segment b2 may be smaller than a reference distance R of the airspace segment, while the relative distances for the third and fourth airspace segments b3 and b4 may be greater than the reference distance R. Accordingly, the airspace segment determination unit 210 may determine a region where the relative distance of the airspace segments a1, b2, b3, b4, b5, and a6 on the planned path is smaller than the reference distance R as the airspace segment.

Preferably, the airspace segment determination unit 210 may compare the relative distances of the airspace segments a1, b2, b3, b4, b5, and a6, and identify whether the airspace segment with a relatively smaller value has a value smaller than the reference distance R.

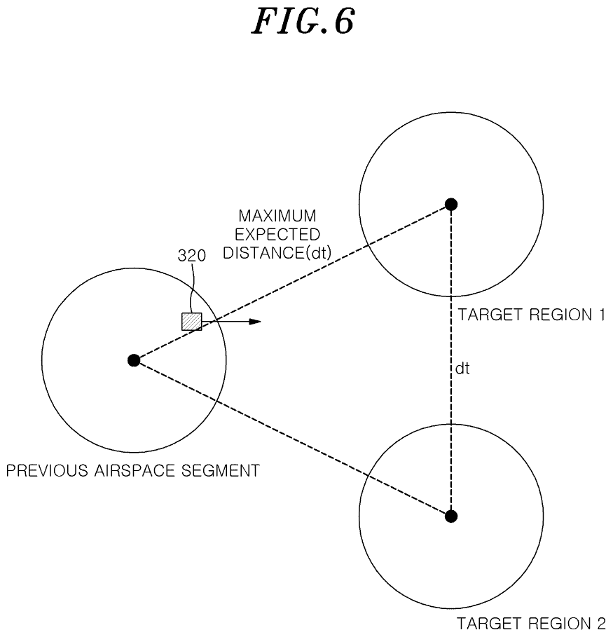

Meanwhile, FIG. 5 is a view illustrating the cell structure of an airspace segment.

In an embodiment, each airspace segment may be divided into cell units with predetermined size and shape. In accordance with the cell unit structure, the center point of the airspace segment and the location of the aircraft may be determined, and the airspace segment determination unit 210 may be configured to calculate the relative distance based on the center point of the airspace segment and the location of the aircraft determined according to the cell unit structure.

Further, as described with reference to FIG. 3 and FIG. 4, the aircraft may not be located within the airspace segment present on the planned flight path and may move off the planned flight path. Accordingly, when an airspace segment is not determined among the airspace segments present on the planned flight path, the airspace segment determination unit 210 may search for an airspace segment by targeting surrounding airspace segments. Specifically, the airspace segment determination unit 210 may detect and store airspace segments at predetermined time units, and identify information on the airspace segment (hereinafter referred to as the ‘previous airspace segment’) that was detected and stored in the previous time unit. Based on this, the airspace segment determination unit 210 may search for the current airspace segment by targeting the surrounding airspace segments located around the previous airspace segment.

FIG. 6 is a view illustrating airspace segments being searched from surrounding airspace segments located around a previous airspace segment.

The airspace segment determination unit 210 may identify the location of the aircraft within the previous airspace segment, as well as the direction vector of the corresponding aircraft and the elapsed time. Therefore, the airspace segment determination unit 210 may calculate a maximum expected distance using the direction vector of the aircraft and the elapsed time. Further, the airspace segment determination unit 210 may predict the airspace segment present within the range of the maximum expected distance as a target region and determine one of the predicted target regions as the airspace segment.

Furthermore, when predicting the target region, the airspace segment determination unit 210 may preferentially determine a predetermined number of target regions (e.g., 2) based on the direction vector of the aircraft. When an airspace segment is not determined among the predetermined number of target regions (e.g., 2) preferentially determined, the airspace segment determination unit 210 may repeatedly perform the operation of predicting the target region by adjusting the search direction or the magnitude of the maximum expected distance.

As another example, the airspace segment determination unit 210 may provide the target region to the user through a graphical user interface (GUI) or the like, and determine the region selected by the user as the airspace segment.

Meanwhile, when the airspace segment determination unit 210 fails to determine the airspace segment through the aforementioned operations, i.e., the operation of determining the airspace segment by targeting the airspace segments on the planned flight path, and the operation of searching the target region to determine the airspace segment, it may expand the search region to determine the airspace segment.

As an example, the airspace segment determination unit 210 may set a predetermined range (e.g., a region between checkpoints set along the flight route) and determine the airspace segment within the set range. That is, the airspace segment determination unit 210 may target the region between the checkpoints set along the flight route, select candidate segments using a k-dimensional tree method, and then search the selected candidate segments to determine the airspace segment. Specifically, the airspace segment determination unit 210 may sort the center points PLᵢ(0,0) of the airspace segments present in the region between the checkpoints set along the flight route in one direction (e.g., a direction from the starting point to the destination), and then, using the center point of the set checkpoint as the root node of the tree, configure the center points of the airspace segments into left and right subtrees. The center point of the airspace segment closest to the center point is used as the root node of the subtree, which is the same for each left and right subtree, and this process is repeated until there is no airspace segment left to finally configure the tree. The airspace segment determination unit 210 may search for candidate segments through the tree configured as described above and determine the relevant airspace segment.

Although, in an embodiment, the airspace segment determination unit 210 is illustrated selecting candidate segments using the k-dimensional tree method, this disclosure is not limited thereto, and the operation of selecting candidate segments may be modified and applied in various ways. For example, the airspace segment determination unit 210 may select candidate segments through at least one or a combination of two or more of the Quad tree method, R-Tree method, Approximate nearest neighbor search method, and Ball tree method. Specifically, the airspace segment determination unit 210 may simplify the flight route into a two-dimensional plane by disregarding altitude information, and apply the Quad tree method to the simplified two-dimensional flight route to select candidate segments. As another example, when frequent searches are expected to occur between specific reference points within the airspace segments, the airspace segment determination unit 210 may configure an index for each airspace segment and apply the R-Tree method to the configured index to select candidate segments. As another example, when the number of candidate airspace segments is sufficiently small and the computational target is considered small, that is, when the number of candidate airspace segments is less than or equal to a predetermined number, the airspace segment determination unit 210 may apply the Approximate nearest neighbor search method to determine the airspace segment with the closest distance from all the airspace segments. As another example, the airspace segment determination unit 210 may configure a virtual set (Ball) that includes all the reference points, then, based on the airspace segment closest to the center point of the corresponding set, configure a virtual subset, and apply the Ball tree method by which the airspace segment closest to the center point of the virtual subset is used as the root of the subtree, to perform the selection of candidate airspace segments and determination of the airspace segment.

As described above, the airspace segment determination unit 210 sequentially performs the operations of determining the airspace segment by targeting the airspace segments on the planned flight path, determining the airspace segment by searching the target region, and determining the airspace segment by searching candidate segments, thereby determining the airspace segment. Accordingly, the airspace segment may be determined quickly and efficiently.

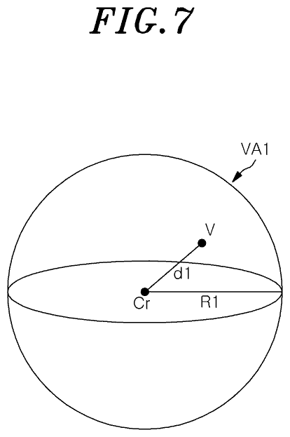

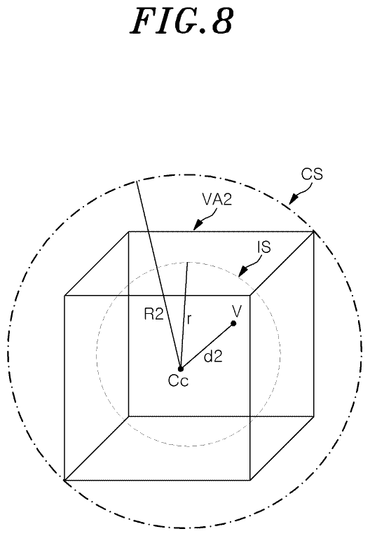

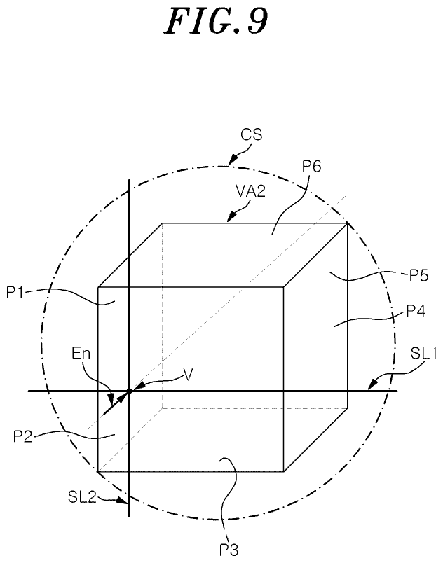

Hereinafter, the relationship between the aircraft and the airspace segment will be described with reference to FIG. 7 and FIG. 8.

FIG. 7 illustrates an airspace segment set in a spherical shape, and FIG. 8 illustrates an airspace segment set in a non-spherical shape.

With reference further to FIG. 7, when a first airspace segment VA1 is set in a spherical shape, the relationship between an aircraft V and the first airspace segment VA1 may be determined based on the comparison between a first distance d1 between a preset center point Cr of the first airspace segment VA1 and the aircraft V, and a preset size R1 of the first airspace segment VA1.

For example, as shown in Equation 2 below, when the first distance d1 between the center point Cr of the first airspace segment VA1 and the aircraft V is less than or equal to the size R1 of the first airspace segment VA1, it may be determined that the aircraft V is located inside the first airspace segment VA1.

d1≤R1 [Equation 2]

Meanwhile, as shown in Equation 3 below, when the first distance d1 between the center point Cr of the first airspace segment VA1 and the aircraft V is greater than the size R1 of the first airspace segment VA1, it may be determined that the aircraft V is located outside the first airspace segment VA1.

d1>R1 [Equation 3]

Meanwhile, with reference further to FIG. 8, when a second airspace segment VA2 is set in a non-spherical shape such as a polyhedron, cylinder, or ellipsoid, an inscribed sphere IS that is inscribed within the second airspace segment VA2 and a circumscribed sphere CS that is circumscribed around the airspace segment may be set for the second airspace segment VA2.

Therefore, based on the comparison between a second distance d2 between a preset center point Cc of the second airspace segment VA2 and the aircraft V, and a radius r of the inscribed sphere IS as well as a radius R2 of the circumscribed sphere CS, the relationship between the aircraft V and the second airspace segment VA2 may be determined.

For example, as shown in Equation 4 below, when the second distance d2 between the center point Cc of the second airspace segment VA2 and the aircraft V is less than or equal to the radius r of the inscribed sphere IS, it may be determined that the aircraft V is located inside the second airspace segment VA2.

d2≤r [Equation 4]

Additionally, as shown in Equation 5 below, when the second distance d2 between the center point Cc of the second airspace segment VA2 and the aircraft V is greater than the radius R2 of the circumscribed sphere CS, it may be determined that the aircraft V is located outside the second airspace segment VA2.

d2>R2 [Equation 5]

Finally, as shown in Equation 6 below, when the second distance d2 between the center point Cc of the second airspace segment VA2 and the aircraft V is greater than the radius r of the inscribed sphere IS but less than or equal to the radius R2 of the circumscribed sphere CS, it may be determined that the aircraft V intersects with the second airspace segment VA2.

r<d2≤R2 [Equation 6]

That is, when the second distance d2 between the center point Cc of the second airspace segment VA2 and the aircraft V is greater than the radius r of the inscribed sphere IS but less than or equal to the radius R2 of the circumscribed sphere CS, depending on the shape of the second airspace segment VA2 and the direction in which the aircraft V is located, the aircraft V may belong to the second airspace segment VA2, or it may not. Therefore, unlike the first airspace segment VA1 set in a spherical shape, the second airspace segment VA2 may have a region that intersects with the aircraft V.

The aircraft presence identification unit 220 may identify whether the aircraft is located within the airspace segment that has been determined to identify the movement state of the aircraft.

In this case, each airspace segment may collect information on the aircraft that has entered or exited itself. In addition, each airspace segment may also collect information on the aircraft that has entered or exited the airspace segment adjacent to each airspace segment. Here, an airspace segment adjacent to an airspace segment refers to an airspace segment that is logically connected to the airspace segment or an airspace segment located within a predetermined distance from the airspace segment.

Therefore, when the aircraft presence identification unit 220 identifies whether the aircraft is located in the airspace segment that has been determined to identify the movement state of the aircraft, it may not only identify whether the aircraft is located in an airspace segment that is targeted for identification, but also identify whether the aircraft is located in the adjacent airspace segment of the airspace segment that is targeted for identification.

According to an embodiment, the adjacent airspace segment may be an airspace segment located outside the region of interest. That is, according to an embodiment, the aircraft presence identification unit 220 may identify whether the aircraft is located in an airspace segment that is located outside the region of interest but adjacent to the region of interest, and is likely to be affected by an event occurring within the region of interest.

As a result of the identification, when the aircraft is located in the airspace segment that has been determined to identify the movement state of the aircraft or in an adjacent airspace segment, the aircraft presence identification unit 220 may transmit the location information of the corresponding aircraft to the movement state determination unit 230.

In contrast, when the result of the identification shows that the aircraft is not located in the airspace segment that has been determined to identify the movement state of the aircraft or in an adjacent airspace segment, the aircraft presence identification unit 220 may inform the airspace segment determination unit 210 that the aircraft is not located in the determined airspace segment, in order to determine another airspace segment to identify the movement state of the aircraft.

The movement state determination unit 230 may determine the movement state of the aircraft based on the location information on the aircraft.

More specifically, the movement state determination unit 230 may determine the direction of movement of the aircraft using the location information on the aircraft, and based on the location information on the aircraft and direction of movement, it may determine the movement state of the aircraft within the airspace segment.

According to an embodiment, the movement state may be expressed in an appropriate manner that represents the situation in which the aircraft is moving within a predetermined airspace segment, such as through a ratio, distance, or time.

According to an embodiment, the movement state determination unit 230 tracks the location information on the aircraft periodically or non-periodically, and as shown in Equation 7 below, it may determine the aircraft's direction of movement Eₙ by using a difference between the most recent location Pₙ of the aircraft and the location Pₙ₋₁ of the previous aircraft.

Eₙ=Pₙ−Pₙ₋₁ [Equation 7]

According to an embodiment, when the airspace segment is set as a polyhedron, the movement state determination unit 230 may determine the movement state, which indicates the extent of movement of the aircraft, based on at least one surface among a plurality of surfaces forming the airspace segment. In this case, according to an embodiment, the movement state may be represented based on the circumscribed sphere of the airspace segment.

That is, for example, when the movement state is expressed as a ratio, the movement state determination unit 230 may generate at least one line that is perpendicular to each of at least one surface and has a length corresponding to the diameter of the circumscribed sphere of the airspace segment. Then, the movement state determination unit 230 may determine the movement state as a ratio of the distance the aircraft has already moved to the distance it will move along the at least one line.

Alternatively, for example, when the movement state is expressed as a distance or time, the movement state determination unit 230 may generate at least one line that is perpendicular to each of at least one surface and has a length corresponding to the diameter of the circumscribed sphere of the airspace segment. Then, the movement state determination unit 230 may determine the movement state as the distance or time the aircraft will move along the at least one line.

According to an embodiment, the at least one surface may include at least one of entry surfaces, where the aircraft enters the airspace segment, and an exit surface, through which the aircraft exits the airspace segment. That is, the movement state determination unit 230, based on at least one of the aircraft's directions of movement or the preset operation path, may determine at least one of the entry surfaces and exit surface of the aircraft among the plurality of surfaces forming the airspace segment. Then, it may determine at least one of the movement states for the entry surface or the movement state for the exit surface.

Alternatively, according to an embodiment, the at least one surface may be determined by the user's selection or preset determination criterion of the movement state determination device 100.

Additionally, according to an embodiment, the movement state determination unit 230 may determine the movement state, which indicates the extent of movement of the aircraft, with respect to the center point of the airspace segment. In this case, according to an embodiment, the movement state may be expressed within the range of (−∞, ∞) based on the aircraft's direction of movement and its location.

For example, when the aircraft is approaching the center point of the airspace segment, the movement state may have a positive value, and when the aircraft is moving away from the center point of the airspace segment, the movement state may have a negative value.

According to an embodiment, the movement state of the aircraft (ProgressLevel) may be expressed as shown in Equation 8 below.

$$ProgressLevel ( V , {E}_{n}^{\to } ) = ( i , o , L ) \qquad [ Equation 8 ]$$

Where V is an aircraft,

$${E}_{n}^{\to }$$

is the aircraft's direction of movement, i is an entry surface, o is an exit surface, and L is the movement state of the aircraft.

FIG. 9 is an example illustrating the movement state of an aircraft based on a surface within an airspace segment set in a polyhedron.

With reference to FIG. 2 and FIG. 9, when the aircraft V is located in the second airspace segment VA2 in the shape of a hexahedron, the movement state determination unit 230, based on the direction of movement Eₙ of the aircraft, may determine that the aircraft V has entered the first surface P1 among the plurality of surfaces P1, P2, P3, P4, P5, and P6 and will exit the sixth surface P6.

The movement state determination unit 230 may determine the movement state of the aircraft V for the entry surface of the aircraft V, which is the first surface P1, and the exit surface of the aircraft V, which is the sixth surface P6, among the plurality of surfaces P1, P2, P3, P4, P5, and P6.

For example, the movement state determination unit 230 may generate a first line SL1 perpendicular to the first surface P1 and having a length corresponding to the diameter of the circumscribed sphere CS of the second airspace segment VA2, and a second line SL2 perpendicular to the sixth surface P6 and having a length corresponding to the diameter of the circumscribed sphere CS of the second airspace segment VA2.

The movement state determination unit 230 may calculate the movement state of the aircraft V on the first line SL1 and the movement state of the aircraft V on the second line SL2 at ratios of 1/4 and 1/3, respectively.

The movement state determination unit 230 may represent the movement state of the aircraft using the calculated values, as shown in Equation 9 below.

$$ProgressLevel ( V , {E}_{n}^{\to } ) = ( P 1 , P 6 , \{ \frac{1}{4} , \frac{1}{3} \} ) \qquad [ Equation 9 ]$$

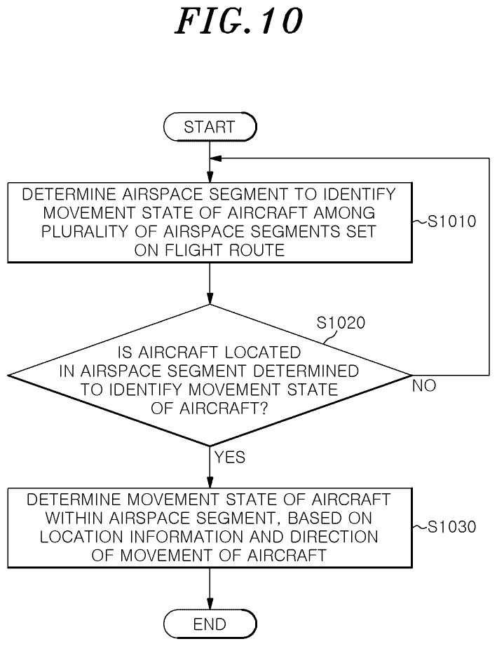

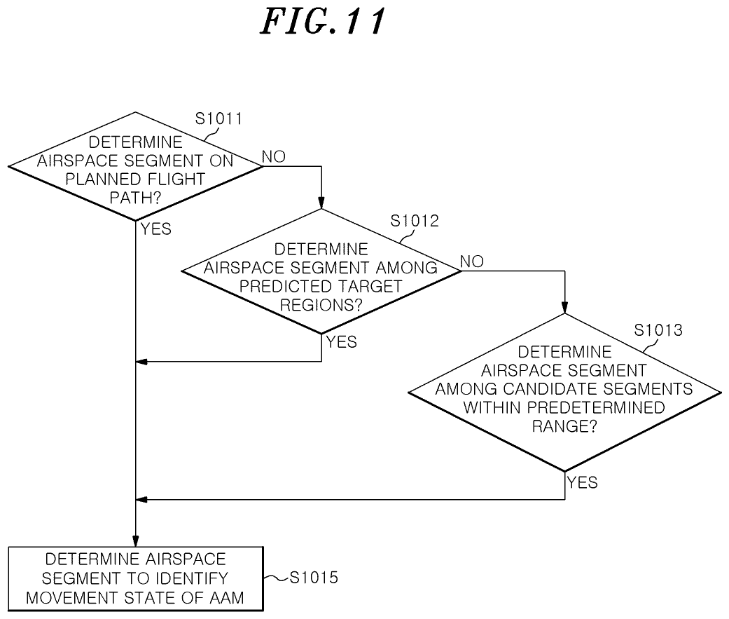

FIG. 10 is a flowchart illustrating a method of determining the movement state of an aircraft according to an embodiment.

With reference to FIG. 1, FIG. 2, and FIG. 7 through FIG. 10, the airspace segment determination unit 210 may determine the airspace segment to identify the movement state of the aircraft among the plurality of airspace segments set along the flight route (S1010).

The aircraft presence identification unit 220 may identify whether the aircraft is located in the airspace segment that has been determined to identify the movement state of the aircraft, according to the predetermined determination criterion (S1020).

As a result of the identification, when the aircraft is located in the airspace segment that has been determined to identify the movement state of the aircraft (S1020, “Yes”), the movement state determination unit 230 may determine the direction of movement of the aircraft using the location information on the aircraft. Based on the location information on the aircraft and direction of movement, it may determine the movement state of the aircraft within the airspace segment (S1030).

In contrast, when the result of the identification shows that the aircraft is not located in the airspace segment that has been determined to identify the movement state of the aircraft (S1020, “No”), the aircraft presence identification unit 220 may determine another airspace segment to identify the movement state of the aircraft based on the predetermined determination criterion.

FIG. 11 is a flowchart illustrating in detail the operation of the step of determining the airspace segment in S1010 of FIG. 10.

With reference to FIG. 1 through FIG. 6, the airspace segment determination unit 210 may preferentially search for the airspace segment by targeting the airspace segments a1, b2, b3, b4, b5, and a6 located on the planned path (S1011). When an airspace segment is determined among the airspace segments on the planned path (S1011, “Yes”), the process may proceed to step S1015 to complete the determination of the airspace segment.

In contrast, when no airspace segment is searched among the airspace segments on the planned path (S1011, “No”), the airspace segment determination unit 210 may predict the surrounding airspace segments located around the previous airspace segment as the target region. The airspace segment determination unit 210 may then search for an airspace segment by targeting one of the predicted target regions (S1012). When an airspace segment is determined within the target region, the process may proceed to step S1015 to complete the determination of the airspace segment.

Meanwhile, when no airspace segment is determined by searching the target region (S1012, “No”), the airspace segment determination unit 210 may set a predetermined range (e.g., a region between checkpoints set along the flight route). Within the defined range, the airspace segment determination unit 210 may select candidate segments using the k-dimensional tree method and then search the selected candidate segments to determine the airspace segment (S1013).

According to an embodiment of the present disclosure, the monitoring of an aircraft within an airspace segment can be performed more precisely by determining the aircraft's movement state within the airspace segment based on its location information and direction of movement.

The combinations of each block in the block diagram attached to the present disclosure and each step in the flowchart may also be executed by computer program instructions. These computer program instructions may be installed on a general-purpose computer, a specialized computer, or other programmable data processing equipment, such that the instructions executed by the encoded processor of the computer or other programmable data processing equipment create means for performing the functions described in each block of the block diagram or each step of the flowchart. These computer program instructions may also be stored in a computer-usable or computer-readable memory that can direct a computer or other programmable data processing equipment to function in a specific manner. Accordingly, the instructions stored in such a computer-usable or computer-readable memory can produce an article of manufacture that includes instruction means for performing the functions described in each block of the block diagram or each step of the flowchart. The computer program instructions may also be loaded onto a computer or other programmable data processing equipment so that a series of operational steps is performed on the computer to generate a computer-executed process, and thus the instructions executed on the computer or other programmable data processing equipment provide steps for implementing the functions described in each block of the block diagram or each step of the flowchart.

The above description merely provides an illustrative explanation of the technical spirit of the present disclosure. It should be understood that various modifications and variations can be made by those skilled in the art to which the present disclosure pertains without departing from the essential qualities of the disclosure. Therefore, the embodiments disclosed in the present disclosure are not intended to limit the technical spirit of the disclosure but to explain it, and the scope of the technical spirit of the disclosure is not limited by these embodiments. The scope of protection of the present disclosure should be interpreted based on the following claims, and all technical ideas within an equivalent scope should be construed as being included within the scope of rights of the present disclosure.

The foregoing description is merely an illustrative explanation of the technical spirit of the present disclosure. It should be understood that various modifications and variations can be made by those skilled in the art to which the present disclosure pertains, without departing from the essential nature of the disclosure. Accordingly, the embodiments disclosed in the present disclosure are not intended to limit the technical spirit of the disclosure but to explain it, and the scope of the technical spirit of the disclosure should not be restricted by these embodiments. The scope of protection of the present disclosure should be interpreted based on the following claims, and all technical concepts within an equivalent scope should be construed as being included within the scope of rights of the present disclosure.

1. A method of determining a movement state of an advanced air mobility (AAM) within an airspace segment, the method comprising:
determining an airspace segment to identify a movement state of an AAM among a plurality of airspace segments set on a flight route;
identifying whether the AAM is located in the determined airspace segment; and
determining the movement state of the AAM within the determined airspace segment based on location information on the AAM when the AAM is located in the determined airspace segment based on a result of the identification.

2. The method of claim 1, wherein the determining of the airspace segment to identify the movement state of the AAM includes:
identifying at least one airspace segment located within a region of interest among the plurality of airspace segments; and
determining an airspace segment to identify a movement state of the AAM among the at least one identified airspace segment, based on a predetermined determination criterion.

3. The method of claim 2, wherein the region of interest is one of a region near a vertiport, a region corresponding to a waypoint, a region corresponding to a dense residential area, a region corresponding to a migratory bird path, a region corresponding to a high-rise building area, or a region where an event has occurred or is expected to occur.

4. The method of claim 1, wherein in the identifying of whether the AAM is located in the determined airspace segment, it is further identified, by the determined airspace segment, whether the AAM is located in an adjacent airspace segment of the determined airspace segment through the airspace segment, and wherein the determining of the movement state of the AAM includes, when the AAM is identified to be located in the adjacent airspace segment, determining the movement state of the AAM within the adjacent airspace segment based on the location information on the AAM.

5. The method of claim 4, wherein the identifying of whether the AAM is located in the adjacent airspace segment is performed using information on the AAM that has entered or exited the adjacent airspace segment, which is obtained from the airspace segment.

6. The method of claim 1, wherein the determining of the movement state of the AAM includes:
determining a direction of movement of the AAM using the location information on the AAM; and
determining the movement state of the AAM within the determined airspace segment based on the location information and the direction of movement.

7. The method of claim 1, wherein the determining of the movement state of the AAM includes:
determining a direction of movement of the AAM using the location information of the AAM;
determining, when a shape of the airspace segment is a polyhedron, an entry surface or an exit surface among a plurality of surfaces constituting the polyhedron, based on at least one of the directions of movement or a preset operation path of the AAM; and
determining a movement state for the determined entry surface or the determined exit surface.

8. The method of claim 1, wherein a shape of the airspace segment is a polyhedron, and the determining of the movement state of the AAM includes:
generating a straight line for each of at least one surface among a plurality of surfaces constituting the polyhedron, wherein the straight line is perpendicular to corresponding surface and has a length corresponding to a diameter of a circumscribed sphere of the determined airspace segment; and
determining a movement state of the AAM with respect to each of the at least one surface, based on a location of the AAM on the straight line generated for each of the at least one surface.

9. The method of claim 1, wherein the determining of the movement state of the AAM includes:
determining a direction of movement of the AAM using the location information of the AAM; and
determining the movement state of the AAM with respect to a center point of the airspace segment based on the location information and the direction of movement.

10. The method of claim 1, wherein the determining of the airspace segment to identify the movement state of the AAM includes:
identifying an airspace segment present on a planned flight path on which the AAM moves from a starting point to a destination;
calculating a relative distance between a center point of the identified airspace segment and a location of the AAM; and
determining the airspace segment to identify the movement state of the AAM based on the calculated relative distance.

11. The method of claim 10, wherein the relative distance is calculated for each of two or more airspace segments present on the planned flight route, and
the method further includes selecting an airspace segment among the two or more airspace segments with the calculated relative distance smaller than a reference distance used to determine a range of the airspace segment, and
wherein the selected airspace segment is determined as the airspace segment for identifying the movement state of the AAM in the determining the airspace segment to identify the movement state of the AAM.

12. The method of claim 11, wherein the selecting the airspace segment among the two or more airspace segments includes:
sorting each of the calculated relative distances in ascending order; and
comparing a relative distance of a smallest value with the reference distance
wherein, when the relative distance of the smallest value is smaller than the reference distance, the airspace segment with the relative distance of the smallest value is determined as the airspace segment to identify the movement state of the AAM.

13. The method of claim 1, wherein the determining of the airspace segment to identify the movement state of the AAM includes:
identifying a previous airspace segment detected in a previous time unit;
identifying a direction vector of the AAM and an elapsed time within the previous airspace segment, and calculating a maximum expected distance based on the direction vector of the AAM and the elapsed time;
predicting airspace segments present within a range of the maximum expected distance as target regions; and
determining one of the predicted target regions as the airspace segment to identify the movement state of the AAM.

14. The method of claim 1, wherein the determining of the airspace segment to identify the movement state of the AAM includes:
selecting candidate segments from among airspace segments present within a predetermined range; and
searching the selected candidate segments to determine the airspace segment to identify the movement state of the AAM.

15. A movement state determination device, comprising:
a memory storing a movement state determination program that includes instructions programmed to determine a movement state of an advanced air mobility (AAM) within an airspace segment; and
a processor configured to execute the movement state determination program to determine an airspace segment to identify the movement state of the AAM among a plurality of airspace segments set on a flight route, identify whether the AAM is located in the determined airspace segment, and, based on a result of the identification, when the AAM is located in the airspace segment, determine the movement state of the AAM within the determined airspace segment based on location information of the AAM.

16. A non-transitory computer-readable recording medium storing instructions, when executed by a processor to cause the processor to determine a movement state of an advanced air mobility (AAM) within an airspace segment, the method comprising:
determining an airspace segment to identify a movement state of an AAM among a plurality of airspace segments set on a flight route;
identifying whether the AAM is located in the determined airspace segment; and determining the movement state of the AAM within the determined airspace segment based on location information on the AAM when the AAM is located in the determined airspace segment based on a result of the identification.
